(19) United States
(12) Patent Application Publication
(10) Pub. No.: US 2008/0020273 A1
(43) Pub. Date: Jan. 24, 2008

(54) Mobile Device Battery

(76) Inventors: Quintin Morris, Brooklyn, NY (US); Katrika Woodcock, Brooklyn, NY (US); Jorg Schlieffers, Berkshire (GB); Christopher N. Crawford, Glen Cove, NY (US)

Correspondence Address: FAY KAPLUN & MARCIN, LLP, 15O BROADWAY, SUITE 702, NEW YORK, NY, 10038, US

(21) Appl. No.: 11/865,832

(22) Filed: Oct. 2, 2007

Related U.S. Application Data
(63) Continuation of application No. 29/252,497, filed on Jan. 24, 2006.

(51) Int. Cl. H01M 2/00; H01M 2/02

(52) U.S. Cl. 429/178

(57) ABSTRACT

Described is a battery which includes a body; a first pair of protrusions extending from a first surface of the body; a second pair of protrusions extending from a second surface of the body opposite to the first surface of the body; a latch disposed on the second surface between the second pair of protrusions; and at least one electrical contact disposed on a third surface of the body.

### PRIORITY CLAIM

This application claims priority to U.S. Design patent application Ser. No. 29/252,497, entitled “Mobile Device Battery,” filed Jan. 24, 2006. The specification of the above-identified application is incorporated herewith by reference in its entirety.

### FIELD OF THE INVENTION

The present invention relates generally to a mobile device battery.

### BACKGROUND

A mobile device utilizes a portable power supply to enable the device to be used in various locations without a need to be permanently connected to an outside power source. The portable power supply may be, for example, a battery. The battery may be disposed within a housing of the mobile device. For example, the housing of the mobile device may be equipped with a receptacle where the battery is received. The battery and the mobile device include a set of contacts so that an electrical connection is established. However, if the battery is not properly received, the contacts may not couple and an electrical connection is not established. Furthermore, even after it is placed in the receptacle, the battery may be dislodged, thereby breaking the electrical connection and possibly resulting in the loss or corruption of data and/or settings stored in the device.

### SUMMARY OF THE INVENTION

The present invention relates to a battery for a mobile device. The battery includes a body; a first pair of protrusions extending from a first surface of the body; a second pair of protrusions extending from a second surface of the body opposite to the first surface of the body; a latch disposed on the second surface between the second pair of protrusions; and at least one electrical contact disposed on a third surface of the body inserted upon approval by the inventors.

### DESCRIPTION OF THE DRAWINGS

FIG. 1 shows a first view of a mobile device battery according to an exemplary embodiment of the present invention.

FIG. 2 shows a second view of a mobile device battery according to an exemplary embodiment of the present invention.

FIG. 3 shows a third view of a mobile device battery according to an exemplary embodiment of the present invention.

FIG. 4 shows a fourth view of a mobile device battery according to an exemplary embodiment of the present invention.

FIG. 5 shows a fifth view of a mobile device battery according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describes a battery for a mobile device (e.g., personal computer, laptop, pager, mobile device, cell phone, radio frequency identification device, scanner, a data acquisition device, an imager, etc.). According to the exemplary embodiments of the present invention, the battery may include protrusions to affix the battery within the mobile device so that an electrical connection is ensured. The battery and the protrusions will be discussed in more detail below.

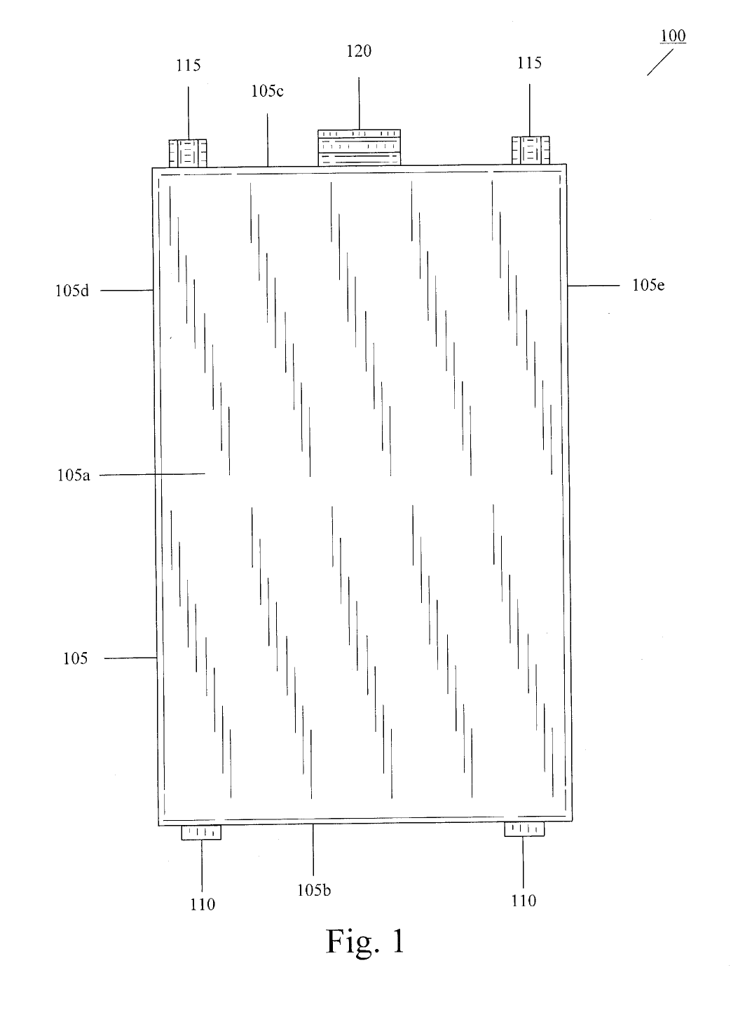

FIG. 1 shows a first view of a mobile device battery 100 according to an exemplary embodiment of the present invention. The battery 100 may exhibit a substantially rectangular solid shape. That is, the battery 100 may include six faces 105a-f. The first view illustrates the first face 105a. The battery 100 may include a body 105, a first pair of protrusions 110, a second pair of protrusions 115, and a latch 120. As will be explained in detail below, the battery 100 may include further components.

The body 105 may be a casing in which components of the battery 100 are disposed within, at least partially within, or on a periphery. For example, the first pair of protrusions 110, the second pair of protrusions 115, and the latch 120 may be disposed on a surface of the body 105. In another example, the battery 100 may include at least one cell that stores energy disposed within the body 105. The body 105 may be manufactured of an insulating material such as a polymer. The body 105 may be a substantially rectangular solid, thereby giving the battery 100 the substantially rectangular solid shape. Thus, the body 105 may include the six faces 105a-f.

The first pair of protrusions 110 may be extensions disposed on the second face 105b of the battery 100. The second face 105b may be a bottom surface of the battery 100. The bottom surface may be a substantially perpendicular face to the first face 105a. The first pair of protrusions 110 may be disposed toward edges of the bottom surface. The constituent parts of the first pair of protrusions 110 will be discussed in further detail below.

The second pair of protrusions 115 may be extensions disposed on the third face 105c of the battery 100. The third face 105c may be a top surface of the battery 100. The top surface may be a substantially perpendicular face to the first face 105a. Furthermore, the top surface may be an opposite face to the bottom surface (i.e., second face 105b). The second pair of protrusions 115 may be disposed toward edges of the top surface. The constituent parts of the second pair of protrusions 115 will be discussed in further detail below.

The latch 120 may be also disposed on the third face 105c of the battery 100. Furthermore, the latch 120 may be disposed toward a middle of the top surface between the second pair of protrusions 115. The constituent parts of the latch 120 will be discussed in further detail below.

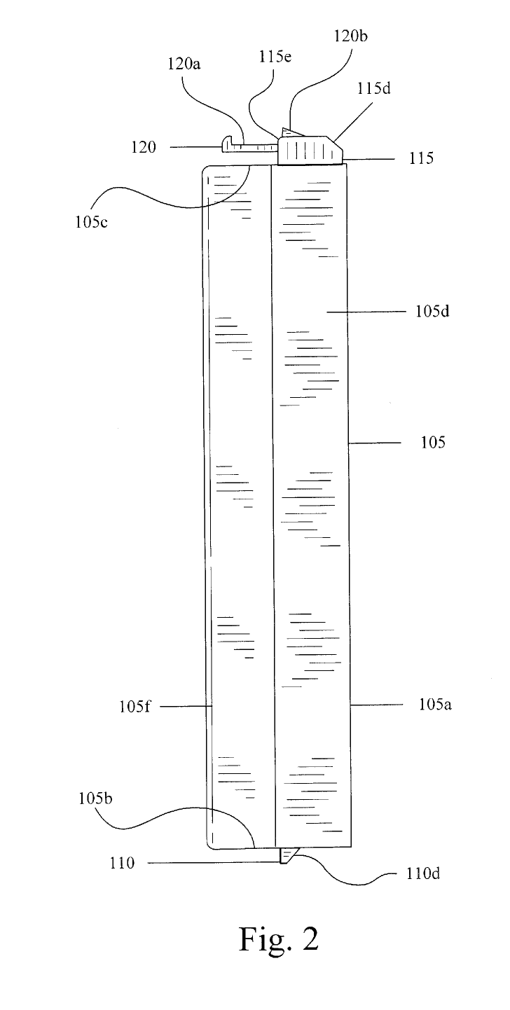

FIG. 2 shows a second view of the mobile device battery 100 according to an exemplary embodiment of the present invention. The second view illustrates the fourth face 105d that is substantially perpendicular to the first face 105a. Specifically, the fourth face 105d may be a side face that is a left side of the first face 105a shown in FIG. 1. It should be noted that the right side face (i.e., fifth face 105e) with reference to the first face 105a shown in FIG. 1 may appear substantially similar to the fourth face 105d except as a mirror image. The second side of the fourth face also shows the body 105, one of the first pair of protrusions 110, one of the second pair of protrusions 115, and the latch 120.

As discussed above, the first pair of protrusions 110 extend from the second face 105b (i.e., bottom surface) of the battery 100. As illustrated, the first pair of protrusions 110 may be disposed toward a middle of the fourth face 105d (i.e., substantially equidistant from the first face 105a and the sixth face 105f). Furthermore, the first pair of protrusions 110 may exhibit a substantially right angled trapezoidal shape. That is, the first pair of protrusions 110 may include an angled side 110d. It should be noted that the position and the shape of the first pair of protrusions 110 are only exemplary.

Also, as discussed above, the second pair of protrusions 115 extend from the third face 105c (i.e., top surface) of the battery 100. As illustrated, the second pair of protrusions 115 may be disposed on the third face 105c toward the first face 105a (i.e., away from the sixth face 105f). Furthermore, the second pair of protrusions 115 may exhibit a substantially rectangular solid shape. In addition, a top right corner 115d of each of the second pair of protrusions 115 may be beveled while a top left corner 115e of each of the second pair of protrusions may be rounded. It should be noted that the position and the shape of the second pair of protrusions 115 are only exemplary.

In the second view of the battery 100, the latch 120 includes a flexible extension 120a that runs parallel to the third face 105c of the battery 100. The flexible extension 120a may be depressed toward the third face 105c. A substantially triangular portion 120b rising above the second pair of protrusions 115 may be a locking mechanism that couples to a recess of the mobile device in which the battery 100 is received. Thus, the depression of the flexible extension 120a may facilitate a release of the triangular portion 120b from the recess.

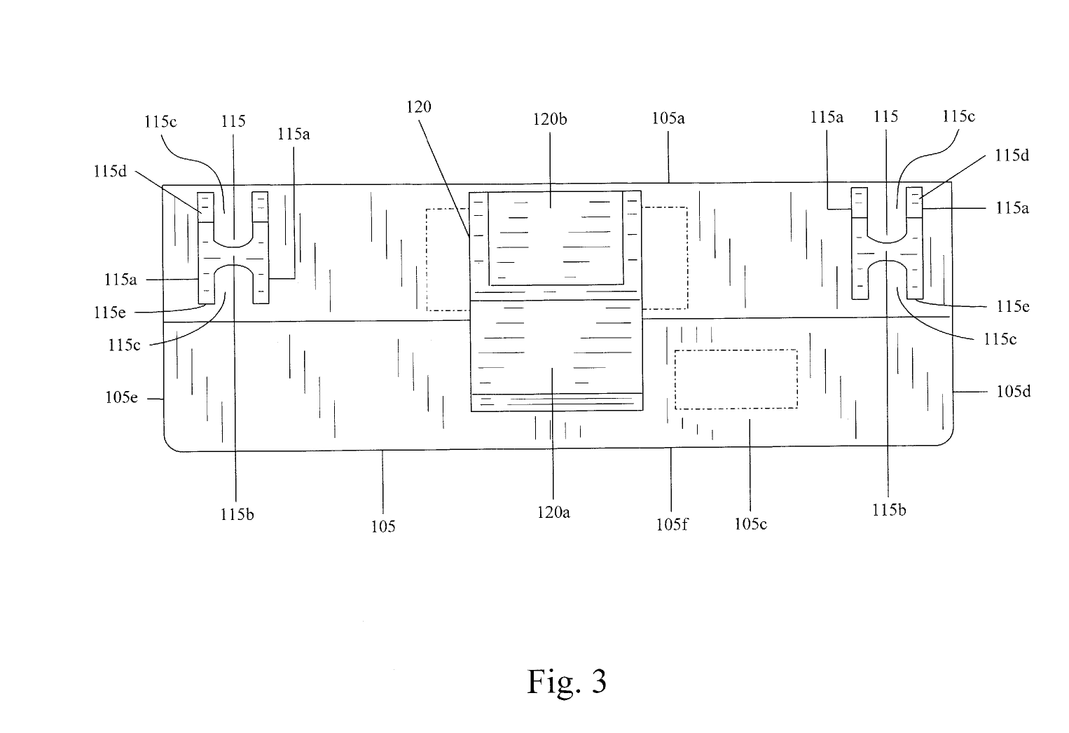

FIG. 3 shows a third view of the mobile device battery 100 according to an exemplary embodiment of the present invention. The third view illustrates the third face 105c that is substantially perpendicular to the first face 105a. As discussed above, the third face 105c may be the top surface of the battery 100. This view of the third face 105c also shows the body 105, the second pair of protrusions 115, and the latch 120.

As discussed above with reference to the second view of FIG. 2, the latch 120 may include a flexible extension 120a. The flexible extension may extend from a top edge of the third face 105c (as viewed in FIG. 3 from a point near the edge that the third face 105c shares with the first face 105a) toward a bottom edge of the third face 105c (i.e., the edge shown between the third face 105c and the sixth face 105f). The triangular portion 120b may be disposed in a top half of the flexible extension 120a. The sides of the flexible extension 120a and the triangular portion 120b may run parallel to the fourth face 105d and the fifth face 105e (i.e., side faces of the battery 100). In addition, the third view further shows that the latch 120 may be disposed in a middle of the third face 105c between the second pair of protrusions 115.

As discussed above, the second pair of protrusions 115 may be disposed toward edges of the third face 105c. The third view shows that the second pair of protrusions 115 may exhibit a substantial H-shape. That is, the H-shape may be created with a pair of substantially parallel walls 115a with a third wall 115b extending between them near a middle of each wall 115a. This configuration may result with the H-shape including recesses 115c. Furthermore, the third view shows that a top side of the second pair of protrusions 115 includes the angled corners 115d while a bottom side of the second pair of protrusions 115 includes rounded corners 115e.

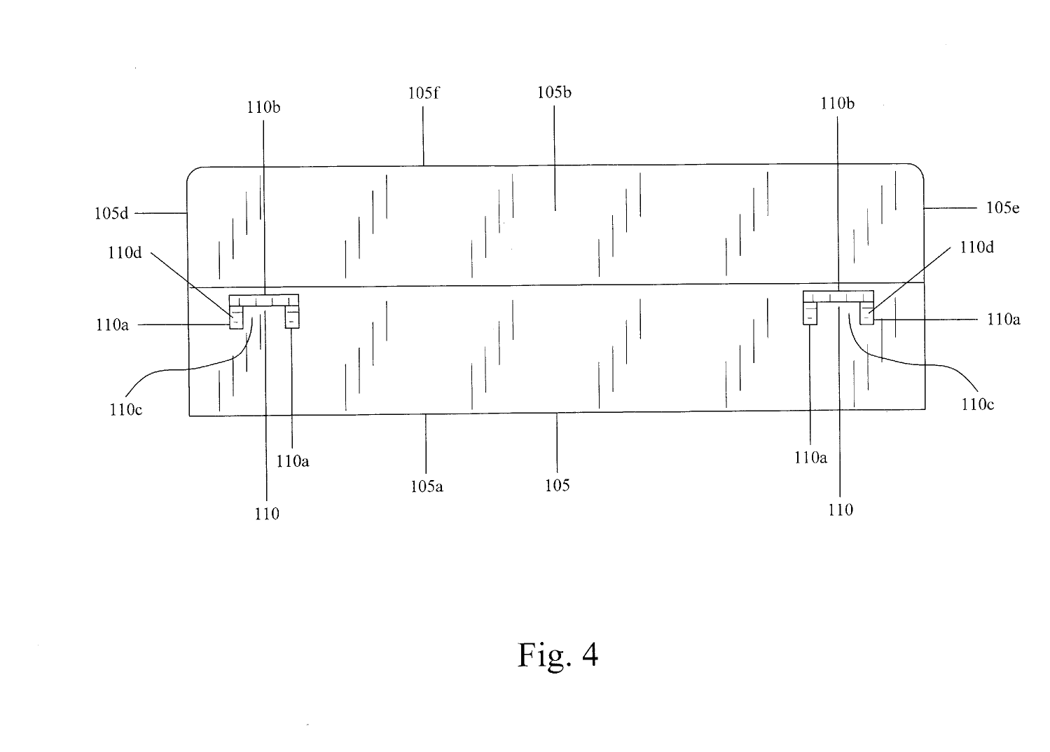

FIG. 4 shows a fourth view of the mobile device battery 100 according to an exemplary embodiment of the present invention. The fourth view illustrates the second face 105b that is substantially perpendicular to the first face 105a. As discussed above, the second face 105b may be a bottom surface of the battery 100. The fourth view of the second face 105b also shows the body 105 and the first pair of protrusions 110.

As discussed above, the first pair of protrusions 110 may be disposed toward edges of the second face 105b. The fourth view of the second face 105b shows that each of the first pair of protrusions 110 may exhibit a substantial U-shape. That is, the first pair of protrusions 110 may include a pair of substantially parallel walls 110a connected with a substantially perpendicular third wall 110b extending between them near a top end of each wall 110a. This configuration may result with the U-shape including a recess 110c on a bottom side of each of the first pair of protrusions 110. Also, as discussed above, the first pair of protrusions 110 may be a trapezoidal shape. Thus, the pair of parallel walls 110a may include the angled side 110d as illustrated in the second view of FIG. 2.

The battery 100 including the first pair of protrusions 110, the second pair of protrusions 115, and the latch 120 may ensure that a proper orientation results when the battery 100 is received within a battery receptacle of the mobile device. As discussed above, each of the first pair of protrusions 100 may be U-shaped and include a recess 110c. The battery receptacle of the mobile device may include complementary extensions that are received by the recesses 110c of the first pair of protrusions 100. Also, as discussed above, each of the second pair of protrusions 115 may be H-shaped that includes a top and bottom recess 115c. The battery receptacle of the mobile device may include complementary extensions that are received by the recess 115c of the second pair of protrusions 115. The latch 120 may lock the battery 100 into the recess of the mobile device. Thus, when the first pair of protrusions 110 and the second pair of protrusions 115 are properly coupled to their complementary components in the battery receptacle, the battery 100 is properly oriented within the battery receptacle of the mobile device. Furthermore, when the latch 120 is locked, a proper orientation is established as the latch 120 may not properly be locked if the battery 100 is improperly oriented.

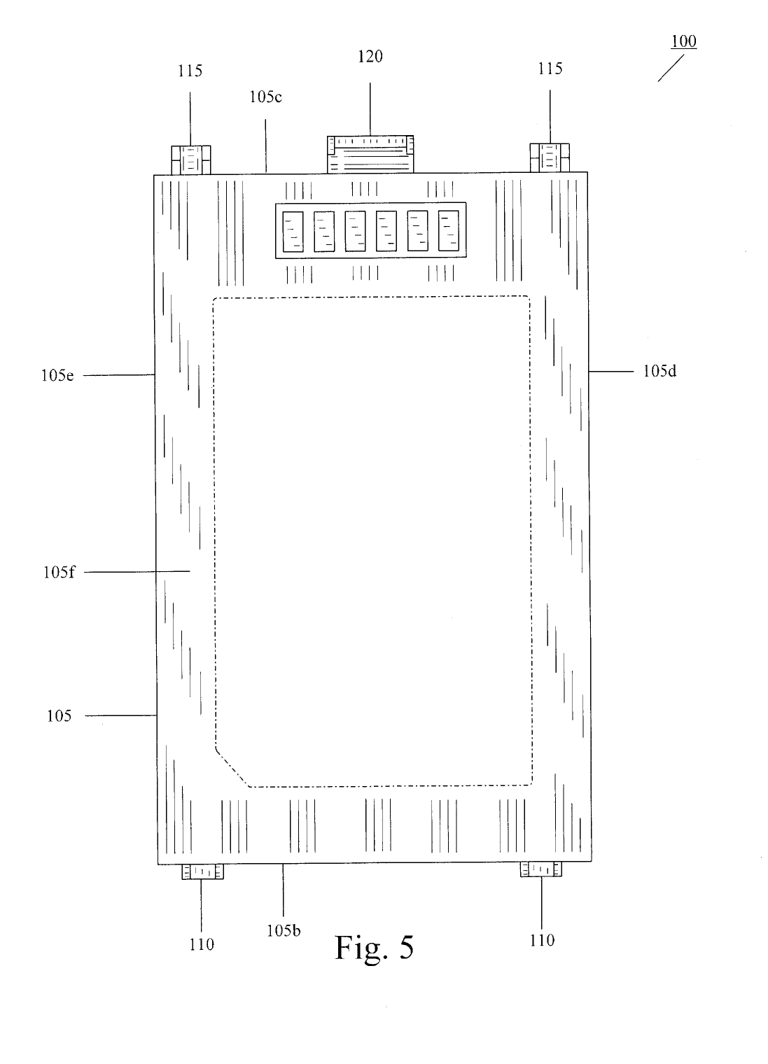

FIG. 5 shows a fifth view of the mobile device battery 100 according to an exemplary embodiment of the present invention. The fifth view illustrates the sixth face 105f that is substantially parallel to the first face 105a. Specifically, the sixth face 105f may be an opposite face with reference to the first face 105a. The fifth view of the sixth face 105f also shows the body 105, the first pair of protrusions 110, the second pair of protrusions 115, and the latch 120. Specifically, the fifth view shows an opposite side of these components with reference to the components illustrated in the first view of FIG. 1. The fifth view further shows that the battery 100 may include a set of contacts 125.

The set of contacts 125 may be coupled to a complementary set of contacts of the mobile device. The complementary set of contacts may be disposed, for example, along an inner wall of the battery receptacle of the mobile device. When the battery 100 is properly received within the battery receptacle of the mobile device, each of the set of contacts 125 may be aligned with one of the complementary set of contacts. The set of contacts 125 may be electrically connected to the cells disposed within the body 105. Thus, the coupling of the set of contacts 125 with the complementary set of contacts may establish an electrical connection so that energy may be drawn by the mobile device from the battery 100.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A battery, comprising:
a body;
a first pair of protrusions extending from a first surface of the body;
a second pair of protrusions extending from a second surface of the body opposite to the first surface of the body;
a latch disposed on the second surface between the second pair of protrusions; and
at least one electrical contact disposed on a third surface of the body.

2. The battery of claim 1, wherein each of the first pair of protrusions includes a first pair of parallel walls and a third wall extending between the first pair of parallel walls.

3. The battery of claim 2, wherein the third wall extends between the first pair of parallel walls at a substantial end of each wall, creating a substantial U-shape.

4. The battery of claim 1, wherein each of the second pair of protrusions includes a second pair of parallel walls and a fourth wall extending between the second pair of parallel walls.

5. The battery of claim 4, wherein the fourth wall extends between the second pair of parallel walls at a substantial middle of each wall, creating a substantial H-shape.

6. The battery of claim 1, wherein the latch includes a flexible member having a first end joined to the second surface.

7. The battery of claim 6, wherein a space is formed between a first surface of the flexible member and the second surface of the body when the flexible member is unbiased.

8. The battery of claim 7, wherein the flexible member includes a first wall running along a length of a second surface of the flexible member that is opposite the first surface of the flexible member.

9. The battery of claim 8, wherein the second surface of the flexible member includes a pair of triangularly-shaped walls that are parallel to each other.

10. The battery of claim 9, wherein the second surface of the flexible member includes a second wall that extends between the pair of triangularly-shaped walls and is disposed parallel to the first wall of the second surface of the flexible member, the first and second walls of the flexible member defining a channel therebetween.

11. A battery, comprising:
a body;
a first pair of protrusions extending from a first surface of the body, each of the protrusions including at least one channel extending therethrough;
a second pair of protrusions extending from a second surface of the body opposite to the first surface of the body, each of the second pair of protrusions having a triangular profile with a squared off corner;
a latch disposed on the second surface between the second pair of protrusions, the latch including a member flexibly depending at one end from the second surface and an opposite end of the member forming a gap with the second surface; and
at least one electrical contact disposed on a third surface of the body.

12. The battery of claim 11, wherein each of the first pair of protrusions includes a first pair of parallel walls.

13. The battery of claim 12, wherein each of the first pair of parallel walls includes a beveled corner at one end and a rounded corner at another end.

14. The battery of claim 12, wherein each of the first pair of protrusions includes a third wall extending between the first pair of parallel walls to form a pair of channels between the first pair of parallel walls that are separated from each other by the third wall.

15. The battery of claim 11, wherein each of the second pair of protrusions includes a fourth wall and a second pair of parallel walls extending from the fourth wall.

16. The battery of claim 15, wherein each of the second pair of walls of the second pair of protrusions includes a flat surface parallel to the second surface of the body.

17. The battery of claim 16, wherein each of the second pair of walls of the second pair of protrusions includes a sloping surface extending from an end of the flat surface to the second surface of the body, the sloping surface forming a non-perpendicular angle with the second surface of the body.

18. The battery of claim 11, wherein a space is formed between a first surface of the flexible member and the second surface of the body when the flexible member is unbiased.

19. The battery of claim 18, wherein the flexible member includes a first wall running along a length of a second surface of the flexible member that is opposite to the first surface of the flexible member.

20. The battery of claim 19, wherein the second surface of the flexible member includes a pair of triangularly-shaped walls that are parallel to each other.

21. The battery of claim 20, wherein the second surface of the flexible member includes a second wall that extends between the pair of triangularly-shaped walls and that is disposed parallel to the first wall of the second surface of the flexible member, the first and second walls of the flexible member defining a channel therebetween.
